(19) United States
(12) Patent Application Publication
(10) Pub. No.: US 2014/0071473 A1
(43) Pub. Date: Mar. 13, 2014

(54) Generic Secondary Resource Referencing Mechanism

(71) Applicants: Reinhard Heinrich Hohensee, Boulder, CO (US); Harry Reese Lewis, Longmont, CO (US)

(72) Inventors: Reinhard Heinrich Hohensee, Boulder, CO (US); Harry Reese Lewis, Longmont, CO (US)

(21) Appl. No.: 13/845,902

(22) Filed: Mar. 18, 2013

Related U.S. Application Data
(60) Provisional application No. 61/700,037, filed on Sep. 12, 2012.

(51) Int. Cl. G06F 3/12

(52) U.S. Cl. CPC G06F 3/1298
USPC 358/1.13

(57) ABSTRACT

A method is disclosed. The method includes generating an object container in a host page description language (PDL) to process generic data objects that are not native to the host PDL, enabling an external object to reference an external object and mapping the external object to a library name familiar to the host PDL.

### FIELD OF THE INVENTION

The present invention relates to the field of printing, and in particular, to referencing secondary resources during print processing.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer. Once a connection is established between a computer and the printer via a print server, printing software running on the server is implemented at a print server to manage a print job through the complete printing process.

Print jobs may be received at the printing software in the form of a page description language (PDL), which describes the appearance of a printed page in a higher level than an actual output bitmap. One such PDL is the Advanced Function Presentation (AFP™). AFP allows a page to be built using native objects and data objects whose formats are not be defined by the AFP presentation architecture, such as Portable Document Format (PDF), Tagged Image File Format (TIFF), Joint Photographic Experts Group (JPEG), etc.

These non-native (non-AFP) objects are normally processed as resources during print processing. Thus in AFP systems, the objects are identified (or mapped) as resources, which cause the print server to download the objects to the printer. The object may then later be included (e.g., using an ID) on the designated pages. However, some of these non-AFP data objects may also reference other objects from within, which are needed to render the data object (e.g., a font, image or color profile). When this occurs, the referenced object is referred to as a secondary resource.

AFP currently supports secondary resources that are unique to PDF. However, support needs to be added for other data formats (e.g., scalable vector graphics (SVG) and portable network graphics (PNG)), each of which support referencing other objects from within. As a result, AFP must be specifically tailored to support secondary resources for these formats. However, having to provide support in AFP for each new industry standard format results in significant development costs. Also, some resources (e.g., fonts) are truly generic in the sense that they may be shared across data objects. Treating these as a secondary resource will avoid multiple caching of the shared resource.

Accordingly, a mechanism to describe and process non-native secondary resources is desired.

### SUMMARY

In one embodiment, a method is disclosed. The method includes generating an object container in a host page description language (PDL) to process generic data objects that are not native to the host PDL, enabling an external object to reference an external object and mapping the external object to a library name familiar to the host PDL.

### BRIEF DESCRIPTION OF THE DRAWINGS

Embodiments of the present invention may be understood more fully from the detailed description given below and from the accompanying drawings of various embodiments of the invention. The drawings, however, should not be taken to be limiting, but are for explanation and understanding only.

FIG. 1 is a block diagram illustrating one embodiment of a print system;

FIG. 2 illustrates a conventional name space mapping process;

FIG. 3 is a flow diagram illustrating one embodiment of performing name space mapping using a generic secondary resource;

FIG. 4 illustrates one embodiment of a generic secondary resource implementation; and

FIG. 5 illustrates one embodiment of a computer system.

### DETAILED DESCRIPTION OF THE INVENTION

A mechanism to process non-native secondary resources is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

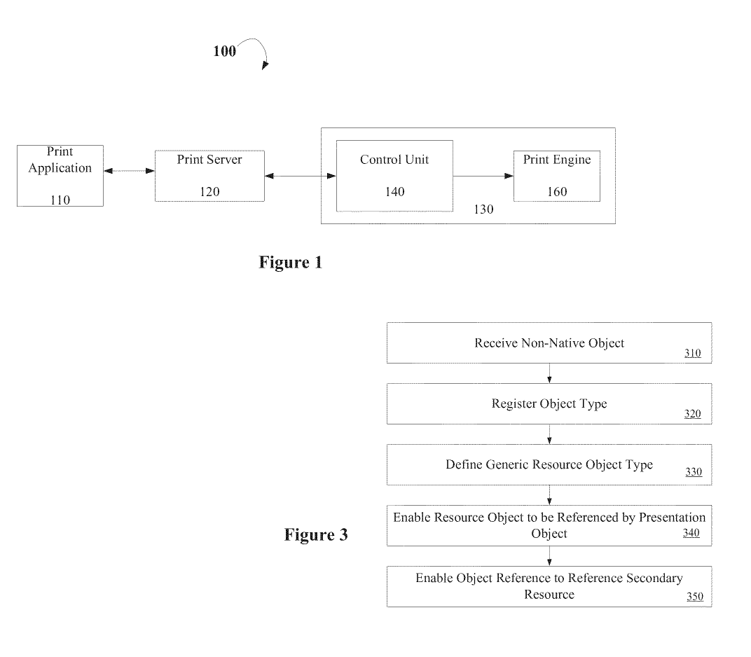

FIG. 1 illustrates one embodiment of a printing system 100. Printing system 100 includes a print application 110, a server 120 and a printer 130 that are implemented to produce documents generated from print jobs. Print application 110 makes a request for the printing of a document. In one embodiment, print application 110 implements the Advanced Function Presentation (AFP™) architecture. According to the AFP architecture, documents may include combinations of text, image, graphics, and/or bar code objects in device and resolution independent formats. These native objects are sometimes referred to as OCA (Object Content Architecture) objects. Documents may also include and/or reference fonts, overlays, color profiles and other resource objects, which are required at presentation time to present the data properly. One form of resource object may be a non-native PDL carried in a generic object container. When disparate PDLs are merged in this fashion, the contained PDL will often reference a secondary resource.

In an AFP embodiment print application 110 provides a Mixed Object Document Content Architecture (MO:DCA) data stream to print server 120. According to one embodiment, the AFP MO:DCA data streams are object-oriented streams including, among other things, data objects, page objects, and resource objects. Print server 120 processes pages of output that mix all of the elements normally found in presentation documents, e.g., text in typographic fonts, electronic forms, graphics, image, lines, boxes, and bar codes. Objects may be stored in a resource library at server 120 for future access. The AFP MO:DCA data stream includes architected, structured fields that describe each of these elements.

For example, the data stream may include Map Data Resource (MDR) and Include Object (IOB) structures fields. The MDR structured field specifies resources that are required for presentation, while the IOB structured field references an object to be presented on a page or overlay. An IOB may also include parameters that identify the object and that specify presentation parameters such as object position, size, orientation, mapping, and default color.

In one embodiment, print server 120 communicates with control unit 140 via an Intelligent Printer Data Stream (IPDS). The IPDS data stream is similar to the AFP data steam, but is built specific to the destination printer in order to integrate with each printer's specific capabilities and command set, and to facilitate the interactive dialog between the print server 120 and the printer. The IPDS data stream may be built dynamically at presentation time, e.g., on-the-fly in real time. Thus, the IPDS data stream is provided according to a device-dependent bi-directional command/data stream.

Printer 130 includes a control unit 140 and a print head 160. Control unit 140 processes and renders objects received from print server and provides sheet maps for printing to print head 160. Control unit 140 includes a rasterizer to prepare pages for printing. Particularly, rasterizer includes a raster image processor (RIP) that converts text and images into a matrix of pixels (bitmap) that will be printed on a page.

According to one embodiment, AFP MO:DCA data streams may include secondary resources, which are resources that are used by objects that are themselves resources. Secondary resources may be explicitly referenced from within an object, or may be implicitly associated with an object by, for example, referencing the secondary resource in the IOB that includes the object. The explicit reference of a secondary resource is implemented using an object container, which is an envelope for object data.

For resource objects, the ability to explicitly reference a secondary resource from with the object is currently limited to PDF, which is a mechanism developed to reference an object type called a “PDF Resource Object”. This secondary resource object can be any resource supported by PDF, and the syntax of the reference is defined by PDF.

However, as discussed above, support for the explicit reference of additional non-native secondary resources is not readily available, and would require a separate mechanism to be developed for each. For example, to support a secondary resource for an SVG object a “SVG resource” could be defined. Without the development of a generic mechanism, the processing of AFP data streams may require non-native secondary resources to be specifically defined for each object type, such as “SVG resource”, “XPS resource”.

Furthermore, unless management of these generic secondary resources is enabled within the host PDL (e.g. AFP), as described herein, high speed production printing could grind to a halt and the performance of other presentation systems be negatively affected if, for example, the language and syntax used requires the secondary resource to be retrieved from the internet.

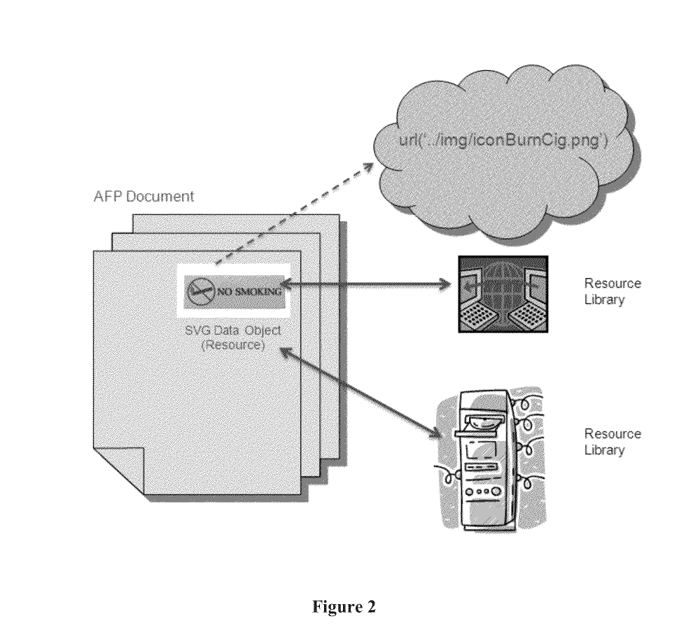

FIG. 2 illustrates a name space mapping implemented to handle non-native/non-PDF secondary resources. As shown in FIG. 2, an AFP document includes a SVG object (e.g., “No Smoking”) image that references a PNG image object (e.g., cigarette with line through). While, the SVG data object may be retrieved from the AFP resource library, without this invention the PNG secondary resource must be retrieved from an external location via the Internet using a URL, as shown by the dotted line. Thus, completion of the processing of the AFP document is dependent on the time necessary to retrieve the PNG object.

According to one embodiment, a name space mapping mechanism is provided to process non-AFP data objects, which are in turn referenced by non-OCA industry-standard resource objects, as generic secondary resources. In such an embodiment, a generic container is provided for data objects that are referenced as secondary resources. This generic container may carry any format supported by the non-OCA presentation object that references the secondary resource. Thus, the generic container mechanism is agnostic to both the format of the data object that references the secondary resource and to the format of the secondary resource object. With this mechanism, the secondary resource (the PNG object in FIG. 2) may be stored in an AFP resource library, recognized and retrieved at print time just like the resource object (the SVG object in FIG. 2) that references it. The speed and integrity of AFP presentation and printing systems is preserved while the array of content available to AFP workflows is widely enhanced.

FIG. 3 is a flow diagram illustrating one embodiment of performing name space mapping using a generic secondary resource. At processing block 310, a non-native (or non-OCA) object is encountered while processing an AFP data stream. In one embodiment, the object is referred to as non-OCA since this format is not one that is defined by the AFP presentation architecture such as the Presentation Text Object (PTOCA), Graphics Object (GOCA), Image Object (IOCA) or Bar Code (BCOCA) formats.

At processing block 320, the non-OCA object type is registered as a presentation object. At processing block 330, the non-OCA secondary resource object is registered as a generic non-OCA secondary resource object type supported in AFP (e.g., non-OCA secondary resource object). At processing block 340, the non-OCA secondary resource object is allowed to be referenced by any non-OCA presentation object. At processing block 350, the non-OCA secondary resource is allowed to be processed (stored in a resource library and downloaded to a printer) by the AFP system. In one embodiment, the referencing is modeled in a manner in which a PDF Resource Object is mapped and referenced. For example, a non-OCA presentation object is mapped using an FQN′DE′ on an MDR and its object type is identified using an X′10′ triplet on that MDR.

In a further embodiment, the non-OCA secondary resource object is referenced and tied to the non-OCA presentation object (e.g. the SVG), with an FQN′DE′/FQN′BE′ pair on the IOB that includes the non-OCA presentation object on the page. The FQN′DE′/FQN′BE′ pair also maps the ID with which the secondary resource is referenced within the non-OCA presentation object (the “internal ID” or “resourceNAME”—BurnCig), to the ID with which the secondary resource is processed in the AFP system (the “external ID” or “libraryNAME”—png1).

Thus, the generic secondary resource object is referenced using the identifier by which it is known to the AFP system (e.g., the name used to install it in a library or carry it in a resource group (the “external ID” or “libraryNAME”—png1)) on a mapping command that identifies this object type as the new generic non-OCA secondary resource, which causes the print server 120 to make the object available in the presentation device. Further, the generic resource is also referenced using the “internal ID” or “resourceNAME (BurnCig) by which it is called out within the presentation object on the command that includes the data object on an AFP page, such as an IOB structured field.

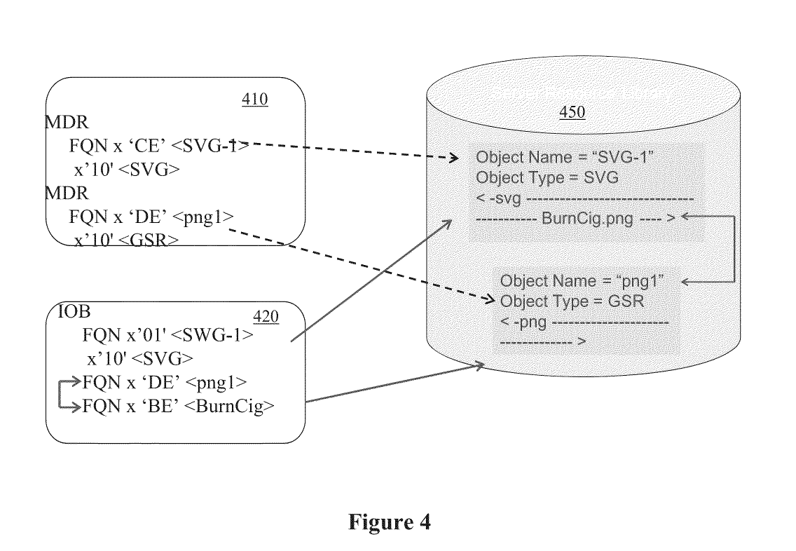

FIG. 4 illustrates one embodiment of the above-described generic secondary resource mapping implementation. For example, box 410 shows the registration and referencing of non-OCA SVG and PNG object types using identifiers described above with reference to processing blocks 330 and 340, while box 420 shows the IOB referencing. Meanwhile box 450 shows how the objects are identified in the resource library.

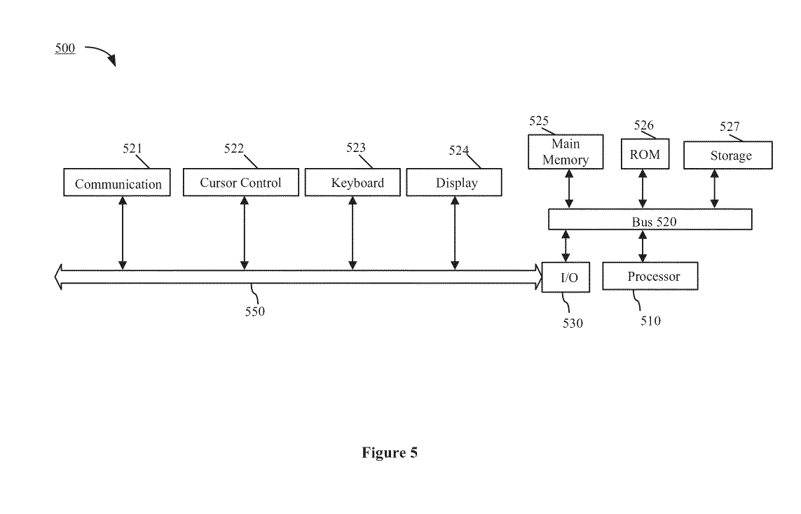

FIG. 5 illustrates a computer system 500 on which print server 120 and printer 130 described with respect to FIG. 1 may be implemented. Computer system 500 includes a system bus 520 for communicating information, and a processor 510 coupled to bus 520 for processing information. According to one embodiment, processor 510 is implemented using one of multitudes of microprocessors. Nevertheless one of ordinary skill in the art will appreciate that other processors may be used.

Computer system 500 further comprises a random access memory (RAM) or other dynamic storage device 525 (referred to herein as main memory), coupled to bus 520 for storing information and instructions to be executed by processor 510. Main memory 525 also may be used for storing temporary variables or other intermediate information during execution of instructions by processor 510. Computer system 500 also may include a read only memory (ROM) and or other static storage device 526 coupled to bus 520 for storing static information and instructions used by processor 510.

A data storage device 525 such as a magnetic disk or optical disc and its corresponding drive may also be coupled to computer system 500 for storing information and instructions. Computer system 500 can also be coupled to a second I/O bus 550 via an I/O interface 530. A plurality of I/O devices may be coupled to I/O bus 550, including a display device 524, an input device (e.g., an alphanumeric input device 523 and or a cursor control device 522). The communication device 521 is for accessing other computers (servers or clients) via an external data network, for example. The communication device 521 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed:

1. A method comprising:
generating an object container in a host page description language (PDL) to process generic data objects that are not native to the host PDL;
enabling an external object to reference an external object; and
mapping the external object to a library name familiar to the host PDL.

2. The method of claim 1 wherein the generic object container supports a format for a non-native industry-standard presentation data object.

3. The method of claim 2 wherein the generic object container further supports a format for the secondary resource referenced by the generic non-native PDL.

4. The method of claim 1 further comprising:
receiving a generic non-native data object included in a print job data stream; and
treating the non-native data object as a contained presentation object.

5. The method of claim 1 wherein enabling the external object to reference the external object provides for proper interpretation and rendering.

6. The method of claim 3 further comprising enabling the secondary resource object to be referenced by a generic non-native presentation object.

7. The method of claim 6 wherein the non-native secondary resource object is referenced using an identifier by which it is known in the non-native presentation object.

8. The method of claim 7 wherein the non-native secondary resource object is also referenced using an identifier by which it is known to the host PDL.

9. The method of claim 1 wherein the PDL comprises the Advanced Function Presentation (AFP).

10. An article of manufacture comprising a machine-readable medium including data that, when accessed by a machine, cause the machine to perform operations comprising:
generating an object container in a host page description language (PDL) to process generic data objects that are not native to the host PDL;
enabling an external object to reference an external object; and
mapping the external object to a library name familiar to the host PDL.

11. The article of manufacture of claim 10 wherein the generic object container supports a format for a non-native industry-standard presentation data object.

12. The article of manufacture of claim 11 wherein the generic object container further supports a format for the secondary resource referenced by the generic non-native PDL.

13. The article of manufacture of claim 10 comprising a machine-readable medium including data that, when accessed by a machine, further cause the machine to perform operations comprising:
receiving a generic non-native data object included in a print job data stream; and
treating the non-native data object as a contained presentation object.

14. The article of manufacture of claim 10 wherein enabling the external object to reference the external object provides for proper interpretation and rendering.

15. The article of manufacture of claim 12 comprising a machine-readable medium including data that, when accessed by a machine, further cause the machine to perform operations comprising enabling the secondary resource object to be referenced by a generic non-native presentation object.

16. The article of manufacture of claim 15 wherein the non-native secondary resource object is referenced using an identifier by which it is known in the non-native presentation object.

17. The article of manufacture of claim 16 wherein the non-native secondary resource object is also referenced using an identifier by which it is known to the host PDL.

18. The article of manufacture of claim 10 wherein the PDL comprises the Advanced Function Presentation (AFP).

19. A print server comprising:
a machine readable medium to store a host page description language (PDL); and
a processor to execute the host page description language (PDL) by generating an object container in a host page description language (PDL) to process generic data objects that are not native to the host PDL, enabling an external object to reference an external object and mapping the external object to a library name familiar to the host PDL.

20. The print server of claim 19 wherein the generic object container supports a format for a non-native industry-standard presentation data object.
